(19) United States
(12) Patent Application Publication
(10) Pub. No.: US 2017/0181191 A1
(43) Pub. Date: Jun. 22, 2017

(54) COMMUNICATION CONTROL DEVICE AND COMMUNICATION CONTROL METHOD

(71) Applicant: FUJITSU LIMITED, Kawasaki-shi (JP)

(72) Inventor: YUN WEN, Kawasaki (JP)

(73) Assignee: FUJITSU LIMITED, Kawasaki-shi (JP)

(21) Appl. No.: 15/335,845

(22) Filed: Oct. 27, 2016

(30) Foreign Application Priority Data
Dec. 16, 2015 (JP) 2015-245409

(51) Int. Cl. H04W 74/08; H04W 52/24; H04W 36/38; H04W 72/04; H04W 72/08; H04W 36/16

(52) U.S. Cl. CPC H04W 74/0816; H04W 72/082; H04W 36/165; H04W 36/38; H04W 72/0453; H04W 52/243; H04W 84/12

(57) ABSTRACT

A communication control device that controls base station devices each of which performs wireless communication with a terminal device, the communication control device includes, an information acquisition unit that acquires information on the base station device, and information on another base station device and a terminal device, terminal detection unit that detects an interfering terminal device being a terminal device, which is present in a communication area of a first base station device, and is in communication with a second base station device which is present outside the communication area of the first base station device and interferes with a radio wave that the first base station device uses for wireless communication, based on the information, and an interference suppression unit that issues an instruction for suppressing interference of a radio wave that the interfering terminal device uses for wireless communication on the information.

### CROSS-REFERENCE TO RELATED APPLICATION

This application is based upon and claims the benefit of priority of the prior Japanese Patent Application No. 2015-245409, filed on Dec. 16, 2015, the entire contents of which are incorporated herein by reference.

### FIELD

The present invention relates to a communication control device and a communication control method.

### BACKGROUND

In recent years, a communication system that arranges a plurality of access points to eliminate an area in which wireless communication cannot be performed is known. When a plurality of access points are arranged, the communication areas of the access points may partially overlap. In a place in which the communication areas overlap, since radio waves transmitted from the plurality of access points arrive in the place, the radio waves may interfere with each other.

According to a method (carrier sense multiple access with collision avoidance (CSMA/CA)), access points measure radio waves to determine whether a radio wave of a frequency to be used from now on is being used, and transmit the radio wave using the frequency when it is determined that the frequency is not being used. In the CSMA/CA method, radio waves are measured before wireless communication starts, and the occurrence of interference of radio waves is suppressed by using a radio wave of a frequency which is determined not to be used.

Techniques for suppressing interference in a communication system are disclosed in Japanese National Publication of International Patent Application No. 2010-508715, Japanese National Publication of International Patent Application No. 2009-533976, and Japanese Laid-open Patent Publication No. 2006-261984.

### SUMMARY

A communication control device that controls a base station device that performs wireless communication with a terminal device, the communication control device includes, an information acquisition unit that acquires information on the base station device and information on another base station device and another terminal device from which the base station device detects radio waves from the base station device, a terminal detection unit that detects a terminal device which is present in a communication area of a first base station device and is in communication with a second base station device which is present outside the communication area of the first base station device and interferes with a radio wave that the first base station device uses for wireless communication based on the information as an interfering terminal device, and an interference suppression unit that issues an instruction for suppressing interference of radio waves that the interfering terminal device uses for wireless communication to at least the second base station device based on the information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a communication system 10.

FIG. 2 is a diagram illustrating an example when interference occurs in the terminal device 100-2.

FIG. 3 is a diagram illustrating a configuration example of the communication control device 300.

FIG. 4 is a diagram illustrating a configuration example of the access point 200.

FIG. 5 is a diagram illustrating an example of the sequence of the interference suppression process.

FIG. 6 is a diagram illustrating an example of surrounding information.

FIG. 7 is a diagram illustrating an example of the flowchart of the interfering terminal detection process.

FIG. 8 is a diagram illustrating an example of the flowchart of a handover candidate determination process.

FIG. 9 is a diagram illustrating an example of a handover instruction.

FIG. 10 is a diagram illustrating a configuration example of the communication control device 300.

FIG. 11 is a diagram illustrating a configuration example of the access point 200.

FIG. 12 is a diagram illustrating an example of the sequence of an interference suppression process.

FIG. 13 is a diagram illustrating an example of surrounding information according to the modification.

FIG. 14 is a diagram illustrating an example of a channel switching instruction.

FIG. 15 is a diagram illustrating an example of the sequence of an interference suppression process.

FIG. 16 is a diagram illustrating an example of the sequence of an interference suppression process.

FIG. 17 is a diagram illustrating an example of surrounding information according to the third embodiment.

FIG. 18 is a diagram illustrating an example of a handover instruction according to the third embodiment.

FIG. 19 is a diagram illustrating an example of beacons transmitted by the access points 200-1 to 200-3 and the states of the beacons received by the terminal device 100-2 in a time-sequential order.

### DESCRIPTION OF EMBODIMENTS

In the CSMA/CA method, it may be difficult to suppress the occurrence of interference. For example, when a radio wave transmitted by an access point (hereinafter referred to as an access point B) near an access point (hereinafter referred to as an access point A) in which radio waves are measured does not arrive in the access point A, the access point A cannot detect the radio wave transmitted by the access point B. In this case, the access point A determines that the radio wave of the frequency in which radio waves are measured is not being used. As a result, the access point A transmits a radio wave of the same frequency as the radio wave transmitted by the access point B and interference of radio waves occurs in an area in which the radio waves of both the access points A and B arrive.

In this manner, in the CSMA/CA method, when a certain access point cannot measure radio waves transmitted by another access point, the access points may transmit radio waves of the same frequency and interference may occur. When interference occurs, the throughput of wireless communication of terminal devices decreases.

### Configuration Example of Communication System

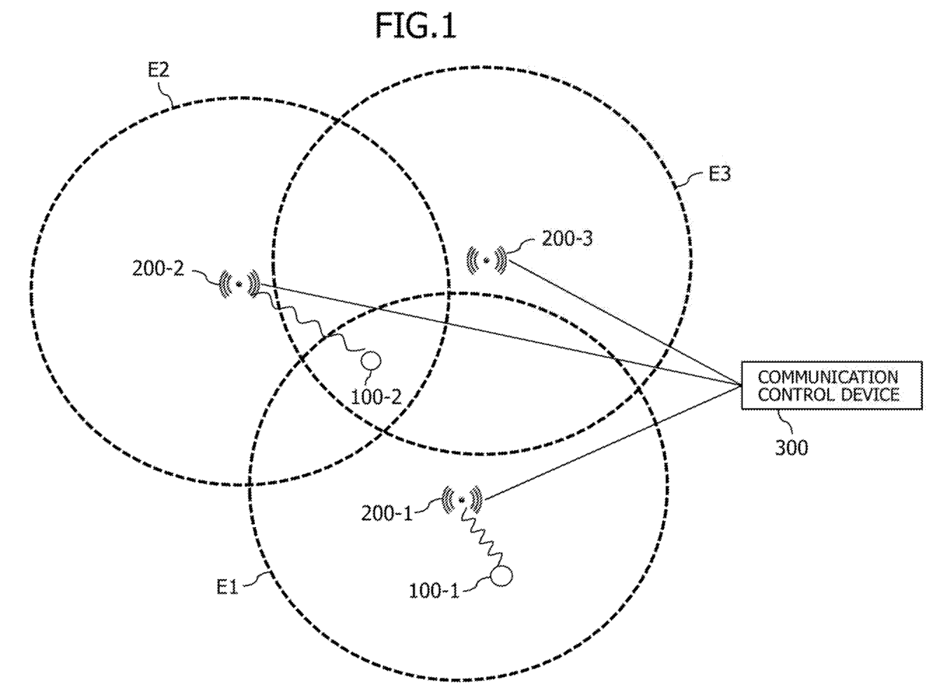

FIG. 1 is a diagram illustrating a configuration example of a communication system 10. The communication system 10 includes terminal devices 100-1 and 100-2, access points 200-1 to 200-3, and a communication control device 300. The communication system 10 is a communication system that provides a communication service to the terminal devices 100-1 and 100-2 so that the terminal devices 100-1 and 100-2 receive the service of a network such as the Internet, for example. The access points 200-1 to 200-3 have communication areas E1 to E3 in which wireless communication with the terminal device 100 can be performed. The terminal devices 100-1 and 100-2 wirelessly connect to the access points 200-1 to 200-3 when the terminal devices are present in the communication areas E1 to E3 to perform wireless communication by transmitting and receiving packets. The frequency used for wireless communication by the terminal devices 100-1 and 100-2 and the access points 200-1 to 200-3 is determined by the access points 200-1 to 200-3 and is allocated to the terminal devices 100-1 and 100-2 that perform wireless communication. When allocating a frequency to the terminal devices 100-1 and 100-2, the access points 200-1 to 200-3 measure whether the frequency is being used based on the CSMA/CA method, for example. When it is checked that the frequency is not being used, the access points 200-1 to 200-3 use the frequency for communication with the terminal devices 100-1 and 100-2. The communication system 10 is a local area network such as wireless fidelity (Wi-Fi) or a wireless communication network such as long term evolution (LTE), for example. The access point 200 may be represented by a base station device. Moreover, the access point 200 is an evolved Node B (eNodeB) in LTE and may be represented by an access point in Wi-Fi, for example.

A storage 220 is an auxiliary storage device that stores programs and data.

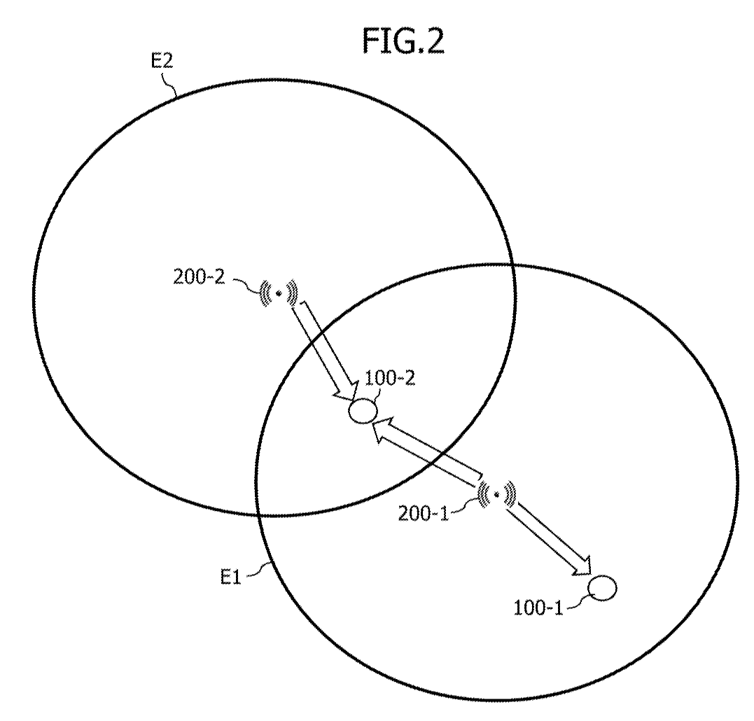

FIG. 2 is a diagram illustrating an example when interference occurs in the terminal device 100-2. In FIG. 2, the terminal device 100-2 is in communication with the access point 200-2 and the terminal device 100-1 is in communication with the access point 200-1. Moreover, the terminal device 100-2 is present in an area in which the communication areas E1 and E2 of the access points 200-1 and 200-2 overlap. Furthermore, the access points 200-1 and 200-2 use the same frequency channel (hereinafter referred to as a channel CH1) for wireless communication.

When starting wireless communication with the access point 200-2, the terminal device 100-2 transmits a connection request message to the access point 200-2 using a control channel. For example, in the case of the CSMA/CA method, upon receiving a connection request message, the access point 200-2 measures radio waves to determine whether the channel CH1 is being used. When the radio measurement result indicates that the channel CH1 is not being used, the access point 200-2 starts wireless communication with the terminal device 100-2 using the channel CH1.

In the case of FIG. 2, since the access point 200-2 is present outside the communication area of the access point 200-1, the radio wave transmitted from the access point 200-1 does not arrive the access point 200-2. Therefore, the access point 200-2 cannot detect the channel CH1 even when radio waves are measured and determines that the channel CH1 is not being used. As a result, the access point 200-2 communicates with the terminal device 100-2 using the channel CH1.

However, in the case of FIG. 2, the access point 200-1 and the terminal device 100-1 perform wireless communication using the channel CH1. The radio wave of the channel CH1 that the access point 200-1 transmits to the terminal device 100-1 in communication also arrives in the terminal device 100-2 present in the communication area of the access point 200-1.

Since both the radio wave of the channel CH1 transmitted from the access point 200-2 and the radio wave of the channel CH1 transmitted from the access point 200-1 to the terminal device 100-1 arrive in the terminal device 100-2, interference between the received radio waves occurs. Due to this, the throughput of communication of the terminal device 100-2 decreases.

The access point 200-1 which cannot detect the radio wave being transmitted and may cause interference with the radio wave of the terminal device 100-2 in communication with the access point 200-2 is referred to as a hidden access point of the access point 200-2.

In the above-description, a case in which communication starts when the terminal device 100-2 is present at a position at which the communication areas of the access points 200-1 and 200-2 overlap as illustrated in FIG. 2 has been described. However, interference also occurs when the terminal device 100-2 which is present outside the communication area of the access point 200-1 starts wireless communication with the access point 200-2 and moves into an area in which the communication areas of the access points 200-1 and 200-2 overlap while maintaining wireless communication.

Furthermore, in FIG. 2, the access point 200-1 is present outside the communication area of the access point 200-2. However, even when the access point 200-1 is present in the communication area of the access point 200-2, interference also occurs if the radio wave transmitted by the access point 200-1 does not arrive in the access point 200-2.

In the communication system 10 of FIG. 1, the communication control device 300 detects a terminal device in which interference occurs in a radio wave used for communication with the access point 200-2 due to a radio wave transmitted by the hidden access point 200-1 during communication with the access point 200-2. Moreover, the communication control device 300 controls the access points 200-1 to 200-3 so that interference does not occur in the detected terminal device. The communication control device 300 communicably connects to the access points 200-1 to 200-3 to acquire information on each access point and information on another access point and another terminal device present in the communication area of each access point from the access points 200-1 to 200-3. Moreover, the communication control device 300 can detect a terminal device which is present in the communication area of a certain access point and in which interference occurs due to a radio wave transmitted from a hidden access point based on the information acquired from the access points 200-1 to 200-3. The communication control device 300 having detected the terminal device in which interference occurs controls the access points 200-1 to 200-3 so as to suppress interference in the terminal device. Interference suppression control involves executing handover the detected terminal device to an access point which uses a channel in which no interference occurs and changing the channel of an access point in communication with the terminal device.

As described above, in the communication system 10, the communication control device 300 detects a terminal device in which interference occurs due to a radio wave transmitted by a hidden access point based on the information acquired from the access points. Moreover, the communication control device 300 controls the access points so as to suppress interference in the detected terminal device. In this manner, it is possible to detect a terminal device in which interference occurs or may occur to suppress interference occurring in wireless communication of the detected terminal device and to prevent a decrease in the throughput of the terminal device.

### First Embodiment

First, a first embodiment will be described.

In the first embodiment, the communication control device 300 detects a terminal device (hereinafter referred to as an interfering terminal device) in which interference occurs or may occur with a radio wave transmitted by a hidden access point during wireless communication with access points. Upon detecting the interfering terminal device, the communication control device 300 controls access points so as to suppress interference of radio waves that the interfering terminal device uses for wireless communication. The communication control device 300 executes handover the interfering terminal device o another access point as control for suppressing interference of radio waves that the interfering terminal device uses for wireless communication.

### Configuration Example of Communication Control Device

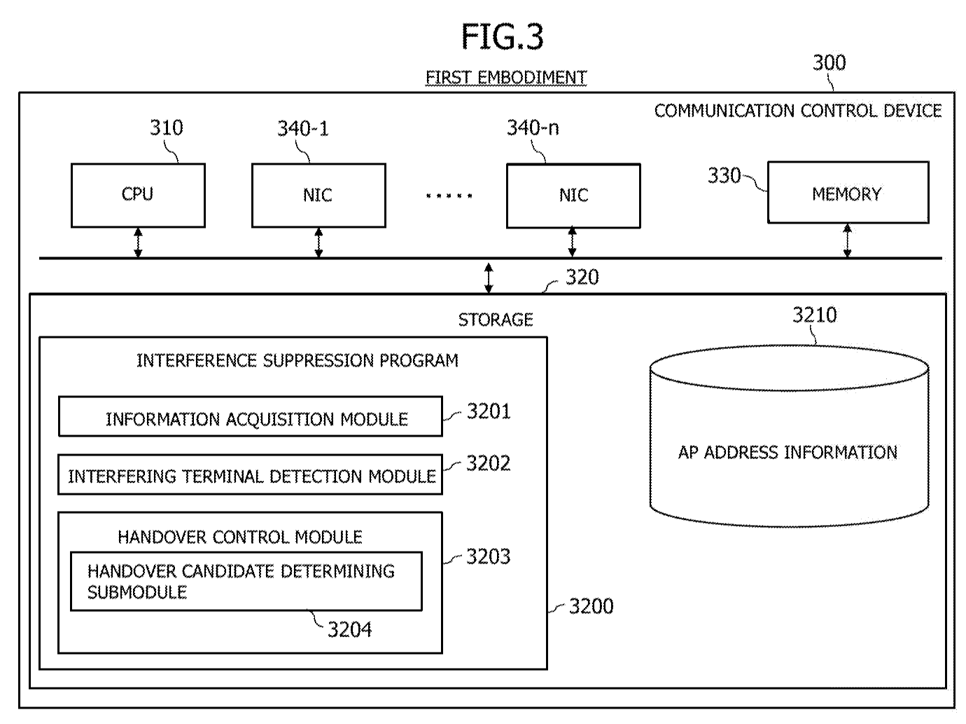

FIG. 3 is a diagram illustrating a configuration example of the communication control device 300.

The communication control device 300 is a computer, for example, and includes a central processing unit (CPU) 310, a storage 320, a memory 330, and network interface cards (NICs) 340-1 to 340-n. The communication control device 300 is a device that controls the access point 200 in the communication system 10.

The storage 320 is an auxiliary storage device that stores programs and data. The storage 320 stores an interference suppression program 3200 and AP address information 3210. The AP address information 3210 includes the address of an access point used when performing communication with an access point controlled by the communication control device 300.

The memory 330 is an area on which a program stored in the storage 320 are loaded. Moreover, the memory 330 is also used as an area in which a program stores data.

The NICs 340-1 to 340-n are devices that perform communication by connecting to the access point 200. The NICs 340-1 to 340-n may connect to an access point via a hub or a switch.

The CPU 310 is a processor that loads a program stored in the storage 320 onto the memory 330 and executes the loaded program to realize respective processes.

The CPU 310 controls the access point 200 by executing modules included in the interference suppression program 3200.

The CPU 310 constructs an information acquisition unit that executes an information acquisition process by executing an information acquisition module 3201. The information acquisition process is a process of acquiring surrounding information from the access point 200. The surrounding information includes information on the access point 200 and information on another access point and another terminal device present in the communication area of the access point 200. The information on the access point 200 and the information on another access point and another terminal device present in the communication area of the access point 200 include the frequency of radio waves that each device use for wireless communication. The information acquisition process is performed periodically, for example. Upon receiving the surrounding information from the access point 200 by the information acquisition process, the communication control device 300 performs an interfering terminal detection process.

Moreover, the CPU 310 constructs a terminal detection unit that executes the interfering terminal detection process by executing an interfering terminal detection process module 3202. The interfering terminal detection process is a process of detecting an interfering terminal device from the received surrounding information. When the radio wave transmitted by a terminal device in wireless communication is likely to interfere with a radio wave transmitted by a hidden access point, the interfering terminal detection process detects the terminal device as an interfering terminal device. In the interfering terminal detection process, when a terminal device is present in an area in which an access point (hereinafter referred to as a communicating access point) in communication with the terminal device overlaps the communication area of each of hidden access points, the terminal device is detected as an interfering terminal device.

In the interfering terminal detection process, an access point that satisfies the following conditions is determined as a hidden access point.

A first condition is that the hidden access point uses a radio wave of a frequency which is the same as or as close as interfering with that of the communicating access point. This is because interference occurs if the radio waves transmitted by the mutual access points collide with each other.

A second condition is that the communication area of the hidden access point partially overlaps the communication area of the communicating access point. This is because the radio waves transmitted by the mutual access points collide with each other in the overlapping area of the communication areas.

A third condition is that the communicating access point is present outside the communication area of the hidden access point (that is, the radio wave transmitted by the hidden access point does not arrive in the communicating access point). This is because, for example, in the CSMA/CA method, when the radio wave transmitted by the access point does not arrive in the communicating access point, since it is not possible to detect the radio wave used by the communicating access point and the radio wave of the frequency is used, interference occurs.

In the interfering terminal detection process, by regarding an access point satisfying the three conditions as a hidden access point of a communicating access point, an interfering terminal device present in the communication area in which both access points overlap is detected.

The CPU 310 constructs an interference suppression unit that executes a handover control process by executing a handover control module 3203. The handover control process issues an instruction to suppress interference occurring in radio waves that the detected interfering terminal device uses for wireless communication. The handover control process performs control to hand the interfering terminal device over to another access point which uses radio waves of a frequency which does not interfere with the radio waves transmitted by the communicating access point and the hidden access point. The handover control process selects an access point serving as a handover candidate, requests the communicating access point to disconnect the connection with the interfering terminal device, and requests access points other than the access point serving as a handover target to do not connect with the interfering terminal device. The communication control device 300 selects a handover candidate in the handover determination process which is realized when the CPU 310 executes a handover candidate determination process submodule 3204.

In the first embodiment, the communication control device 300 detects the interfering terminal device and controls access points so that interference does not occur. In this way, it is possible to suppress occurrence of interference in wireless communication of a terminal device and to suppress a decrease in the throughput of the terminal device.

### Configuration Example of Access Point

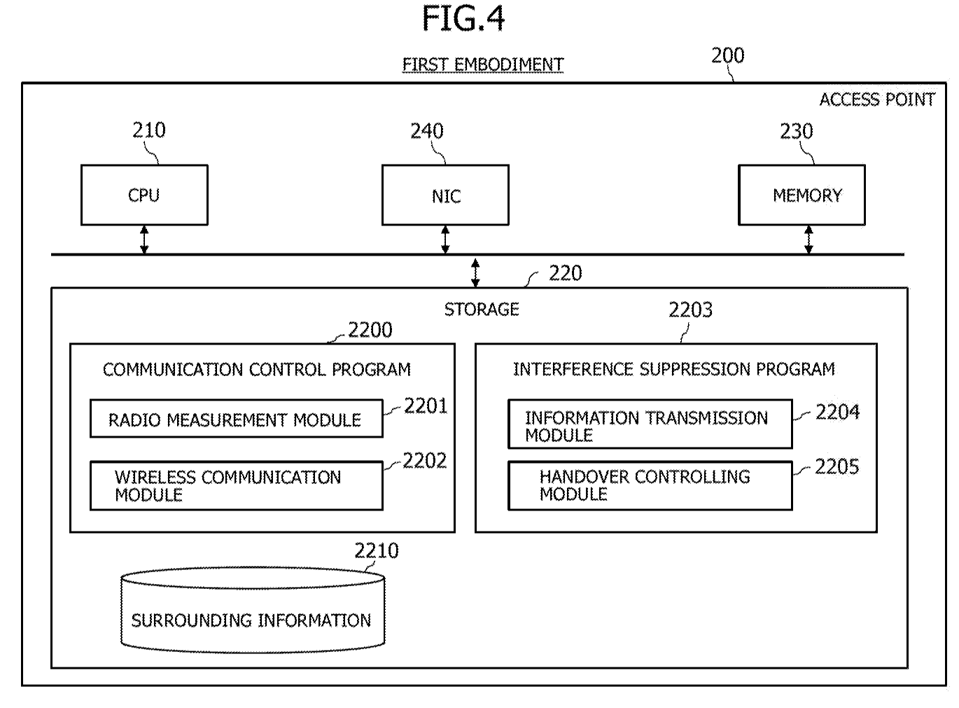

FIG. 4 is a diagram illustrating a configuration example of the access point 200.

The access point 200 includes a CPU 210, a storage 220, a memory 230, and an NIC 240. The access point 200 is a wireless communication device that performs by wirelessly connecting to the terminal device 100. Moreover, the access point 200 is a device controlled by the communication control device 300.

The storage 220 stores a communication control program 2200, an interference suppression program 2203, and surrounding information 2210. The surrounding information 2210 is surrounding information of the access point 200 and is acquired periodically, for example. The access point 200 transmits the surrounding information in response to a request from the communication control device 300. The details of the surrounding information will be described in the sequence of an interference suppression process described later.

The memory 230 is an area on which a program stored in the storage 220 is loaded. Moreover, the memory 230 may be also used as an area in which a program stores data.

The NIC 240 is a device that performs communication by connecting to the communication control device 300. The NIC 240 may be connected to the communication control device 300 via a hub or a switch.

The CPU 210 is a processor that loads a program stored in the storage 220 onto the memory 230 and executes the loaded program to realize respective processes.

The CPU 210 constructs a communication control unit that executes a communication control process by executing modules included in the communication control program 2200. The communication control process is a process that performs wireless communication by connecting to a terminal device. The communication control process includes a radio measurement process realized when the CPU 210 executes a radio measurement module 2201 and a wireless communication process realized when the CPU 210 executes a wireless communication module 2202.

The radio measurement process is a process of measuring radio waves to determine whether a frequency used for wireless communication is used in a radio segment when starting wireless communication with a terminal device. When a measurement target radio wave is received with a predetermined intensity or higher, it is determined that the radio wave of the frequency is being used. Moreover, the radio measurement process searches for another access point and another terminal device present in the communication area. The access point 200 detects another access point and another terminal device which could receive transmitted radio waves and stores the detected access point and terminal devices in the surrounding information 2210.

The communication control process is a process of controlling wireless communication with a terminal device and involves routing packets transmitted and received by the terminal device and monitoring a communication state of wireless communication.

The CPU 210 realizes an interference suppression process in response to interference suppression control from the communication control device 300 by executing modules included in the interference suppression program 2203. The interference suppression process includes an information transmission process realized by the CPU 210 executing an information transmission module 2204 and a handover controlling process realized by executing a handover controlling module 2205.

The information transmission process is a process of transmitting surrounding information to the communication control device 300 when a surrounding information transmission request is received from the communication control device 300. The access point 200 acquires surrounding information by measuring radio waves transmitted from terminal devices and another access point present in the communication area in the radio measurement process of the communication control process, for example.

The handover controlling process is a process of controlling communication with a terminal device according to an instruction from the communication control device 300. The access point sends a response to a connection request from an interfering terminal device and performs wireless communication with the interfering terminal device if the subject device is a handover candidate. Moreover, the access point disconnects the connection with the interfering terminal device when the interfering terminal device is in communication with the subject device.

### Interference Suppression Process

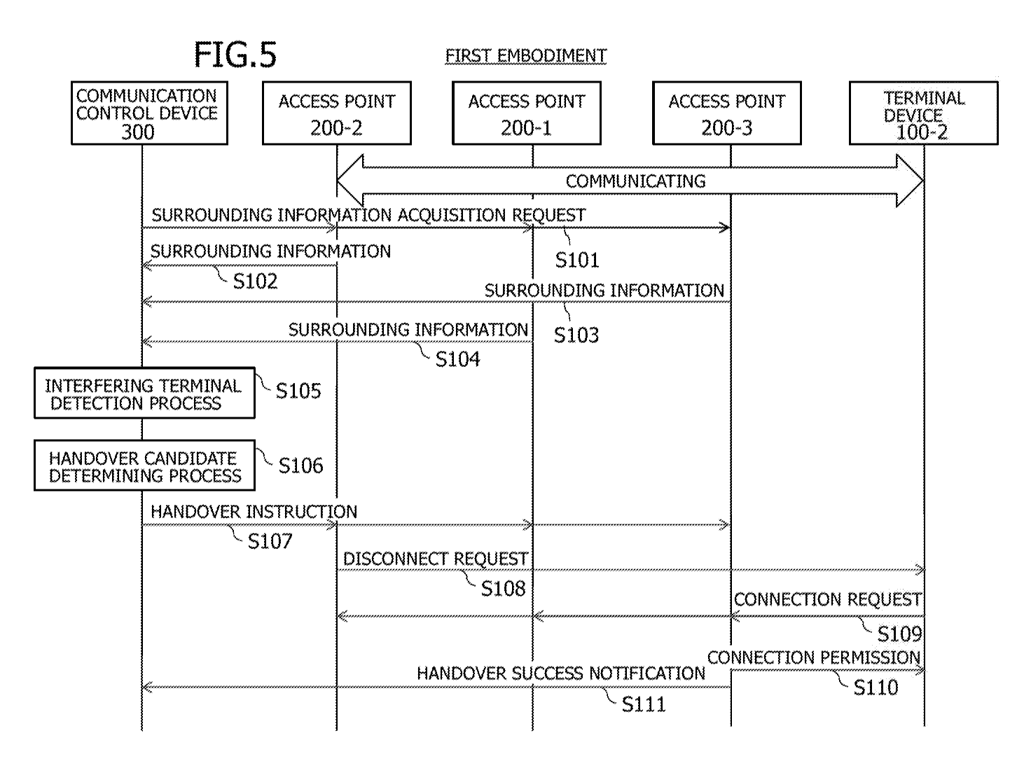

FIG. 5 is a diagram illustrating an example of the sequence of the interference suppression process. Hereinafter, the interference suppression process will be described with reference to FIG. 5. At the start of the sequence, the terminal device 100-2 is in wireless communication with the access point 200-2.

The communication control device 300 transmits a surrounding information acquisition request periodically, for example, to all access points that forms the communication system 10 (S101). In the sequence of FIG. 5, the communication control device 300 transmits the surrounding information acquisition request to the access points 200-1 to 200-3.

Upon receiving the surrounding information acquisition request, the access points 200-1 to 200-3 transmit surrounding information to the communication control device 300 (S101 to S103). The access points 200-1 to 200-3 may transmit the surrounding information stored in an internal memory and may perform search for acquiring surrounding information upon receiving the surrounding information acquisition request.

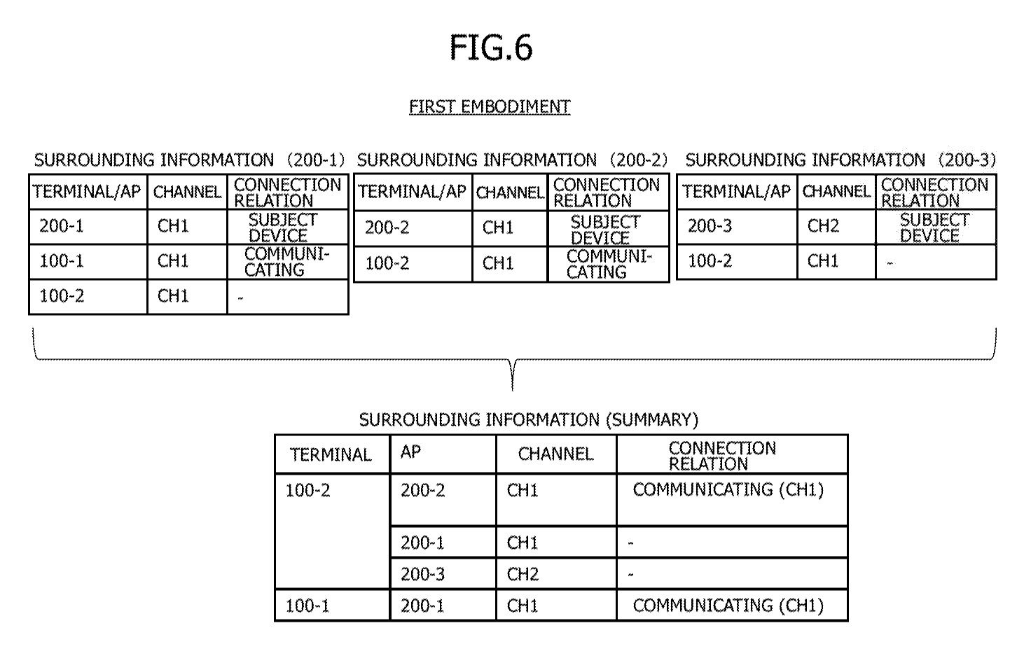

FIG. 6 is a diagram illustrating an example of surrounding information. In FIG. 6, “surrounding information (xxxx)” (“xxxx” is 200-1 to 200-3) is surrounding information transmitted by an access point xxxx, and “surrounding information (summary)” is information in which the surrounding information received from access points is summarized for each terminal device.

The surrounding information transmitted by the access points includes information elements such as “terminal/AP,” “channel,” and “connection relation”. The “terminal/AP” is an identifier of an access point and a terminal device in which the access point could receive radio waves, and the identifier is international mobile equipment identity (IMEI) for terminal devices and service set identifier (SSID) for access points. The “channel” is a channel number of a channel which is being used by a terminal device in communication and a channel which can be used by an access point. For example, when a 2.4-GHz band is used in a wireless LAN, the channel CH1 is a frequency band between 2401 MHz and 2423 MHz. That is, the frequency used by each device is uniquely determined by the channel number. The “connection relation” is a relation with an access point that transmits the surrounding information. “Subject device” indicates that an access point is the access point that transmits the surrounding information, and “communicating” indicates that an access point is performing wireless communication with the terminal device.

The “surrounding information (summary)” includes information elements such as “terminal,” “AP,” “channel,” and “connection relation”. The “terminal” is an identifier of a terminal device, and the “AP” is an identifier of an access point present in the communication area of the terminal device. The “connection relation” indicates a connection relation between a terminal device and an access point, and “communicating (CH1)” indicates that the terminal device is communicating with the access point and uses the channel CH1 for wireless communication.

The surrounding information received from each access point is another access point and another terminal device in which radio waves have received the access point. In other words, the access point can be said to be present in the communication area of another access point and another terminal device. In the present embodiment, a case in which the communication areas of respective access points are the same ranges and the communication area of a terminal device is the communication area of each access point will be described. In this case, the fact that the access point is present in the communication area of another access point and another terminal device means that the other access point and the other terminal device are present in the communication area of the access point. On the other hand, when the communication areas of respective devices are not the same, the communication control device 300 can detect the other access point and the other terminal device present in the communication areas of the respective access points by collecting the received surrounding information.

Upon acquiring the surrounding information from all access points, the communication control device 300 performs an interfering terminal detection process (S105). Hereinafter, the interfering terminal detection process will be described.

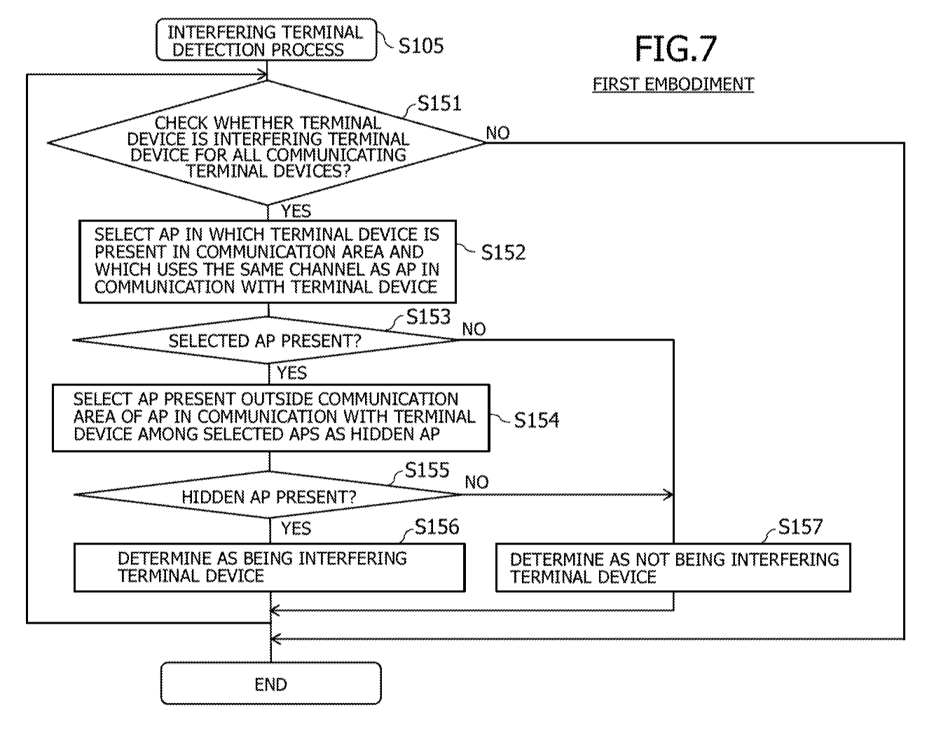

FIG. 7 is a diagram illustrating an example of the flowchart of the interfering terminal detection process. The communication control device 300 checks whether a terminal device is an interfering terminal device with respect to all communicating terminal devices. The process is continued until the checking of all communicating terminal devices ends (S151: No). In FIG. 6, the terminal devices 100-1 and 100-2 are communicating terminal devices, and it is checked whether the two terminal devices are interfering terminal devices. Hereinafter, the terminal device 100-2 will be described by way of an example.

First, an access point in which a terminal device is present in the communication area thereof and which uses the same channel as an access point with which the terminal device is communicating (S152). For example, referring to the “surrounding information (summary)” in FIG. 6, the terminal device 100-2 is in communication with the access point 200-2 and uses the channel CH1. Referring to the surrounding information of each access point in FIG. 6, the access point which uses the channel CH1 includes the access point 200-1 other than the access point 200-2. In the selecting process S152, the access point 200-1 is selected.

When an access point selected in the selecting process S152 is present (S153: Yes), the communication control device 300 selects an access point in which an access point in communication with a terminal device is present outside the communication area among the selected access points as a hidden access point (S154). The fact that the communicating access point is present outside the communication area of a certain access point means that a radio wave transmitted by the access point has not arrived in the communicating access point and the communicating access point cannot detect a radio wave by radio measurement. Referring to the “surrounding information (200-1)” in FIG. 6, since the access point 200-2 in communication with the terminal device 100-2 is not present in the communication area of the selected access point 200-1, the communication control device 300 selects the access point 200-1 as a hidden access point.

When a hidden access point is selected in the hidden access point selecting process S154 (S155: Yes), the communication control device 300 detects the terminal device as an interfering terminal device. In the case of FIG. 6, the terminal device 100-2 is detected as an interfering terminal device (S156).

When an access point selected in the selecting process S152 is not present (S153: No), and a hidden access point selected in the hidden access point selecting process S154 is not present (S155: No), it is determined that the terminal device is not an interfering terminal device (S157).

Returning to the sequence of FIG. 5, the communication control device 300 performs a handover candidate determination process (S106) when an interfering terminal device is detected in the interfering terminal detection process S105. Hereinafter, a handover candidate determination process will be described.

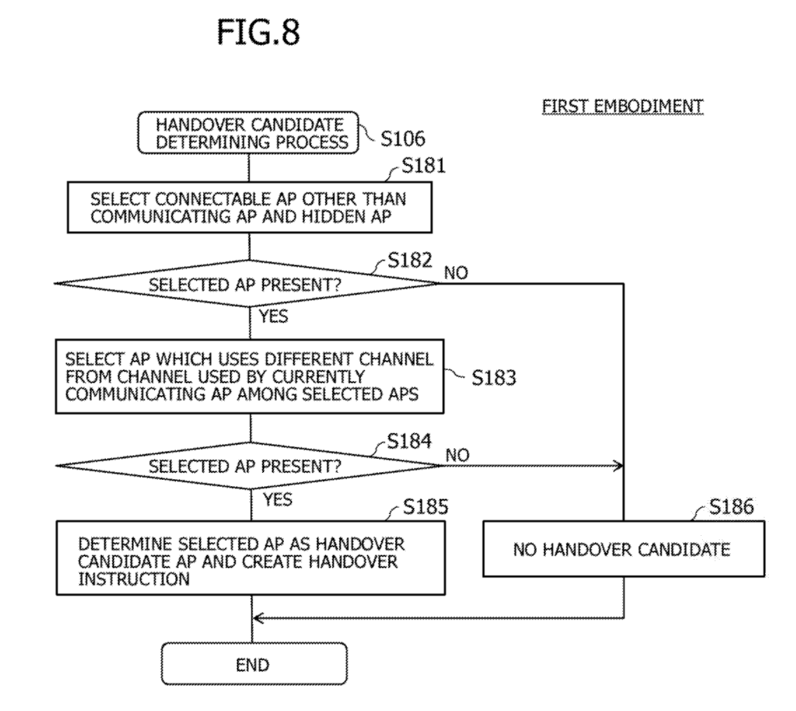

FIG. 8 is a diagram illustrating an example of the flowchart of a handover candidate determination process. The communication control device 300 selects an access point to which the interfering terminal device can connect other than the access point in communication with the interfering terminal device and the hidden access point (S181). Referring to the “surrounding information (summary)” in FIG. 6, the access point 200-3 other than the communicating access point 200-2 and the access point 200-1 determined as the hidden access point is selected as an access point to which the terminal device 100-2 can connect.

When an access point selected in the selecting process S181 is present (S182: Yes), an access point which uses a channel different from the channel used by the communicating access point among the selected access points is selected (S183). Referring to the “surrounding information (200-3)” in FIG. 6, the access point 200-3 which uses a channel CH2 different from the channel CH1 used by the communicating access point 200-2 is selected.

Although not illustrated in FIG. 8, when an interfering terminal device communicates with a handover candidate access point and a hidden access point of the handover candidate access point is present, handover candidate access points may be further narrowed down to an access point in which a hidden access point is not present in S183. For example, in the example of FIGS. 1 and 6, another access point (not illustrated) which uses a different channel from the handover candidate access point 200-3 and in which a hidden access point is not present in relation to the channel may be selected as a handover candidate. In this manner, it is possible to prevent an interfering terminal device from being detected again as an interfering terminal device in communication with a handover destination access point after the interfering terminal device performs handover.

When an access point is selected in the selecting process S183 (S184: Yes), the selected access point is determined as a handover candidate access point and a handover instruction is created (S185).

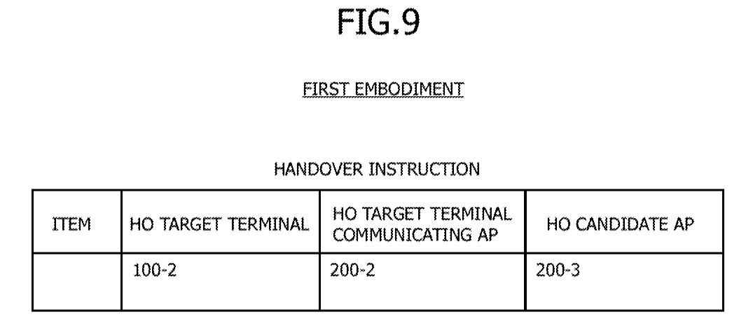

FIG. 9 is a diagram illustrating an example of a handover instruction. The information included in the handover instruction includes “HO target terminal,” “HO target terminal communicating AP,” and “HO candidate AP”. The “HO target terminal” is an interfering terminal device which is a handover target terminal device. In the case of FIG. 9, the “HO target terminal” is the identifier of the terminal device 100-2. The “HO target terminal communicating AP” is an identifier of an access point which is in communication with the interfering terminal device. In the case of FIG. 9, the “HO target terminal communicating AP” is the identifier of the access point 200-2 which is in communication with the terminal device 100-2. The “HO candidate AP” is an identifier of a candidate access point serving as a destination for a handover destination of the interfering terminal device. In the case of FIG. 9, the “HO candidate AP” is the identifier of the access point 200-3 determined in the handover candidate determination process S106. A plurality of handover candidate access points may be present.

Returning to the sequence of FIG. 5, the communication control device 300 transmits a handover instruction to all access points that form the communication system 10 (S107). The communication control device 300 may transmit a handover instruction to an access point in which the interfering terminal device is present in the communication area thereof rather than transmitting the same to all access points that form the communication system 10.

Upon receiving the handover instruction, each access point checks whether the subject device is the “HO target terminal communicating AP”. When the “HO target terminal communicating AP” is the subject device, the access point disconnects the communication with the terminal device described in the “HO target terminal” of the handover instruction. In the case of FIG. 9, since the “HO target terminal communicating AP” is the access point 200-2 and the “HO target terminal” is the terminal device 100-2, the access point 200-2 transmits a disconnect request to the terminal device 100-2 in order to disconnect wireless connection (S108). The terminal device 100-2 having received the disconnect request disconnects the connection with the access point 200-2 and broadcasts a connection request using a control channel (S109).

The access points 200-1 to 200-3 receive the connection request from the terminal device 100-2. An access point having received the connection request transmits a connection permission to the terminal device 100-2 when the subject device is included in the “HO candidate AP” of the handover instruction. An access point which is not included in the “HO candidate AP” discards the connection request and ends the process. In the case of FIG. 9, the access point 200-3 which is the “HO candidate AP” transmits a connection permission to the terminal device 100-2 (S110) and starts wireless communication. When starting wireless communication, the access point 200-3 transmits a handover success notification including the identifier of the terminal device 100-2 to the communication control device 300. Moreover, since the access points 200-1 and 200-2 are not the handover target access point, the access points 200-1 and 200-2 discard the connection request from the terminal device 100-2.

In the first embodiment, the communication control device 300 detects an interfering terminal device in which interference occurs due to a hidden access point and controls access points to hand an interfering terminal device over to another access point in which interference does not occur. In this manner, it is possible to suppress interference occurring in the radio wave of the interfering terminal device and to suppress a decrease in the throughput of terminal devices resulting from the occurrence of interference.

### Modification

In the first embodiment, the communication control device 300 hands the interfering terminal device over to another access point. In a modification, the communication control device 300 controls access points in communication with the interfering terminal device so as to change the frequency (channel) used.

### Configuration Example of Communication Control Device

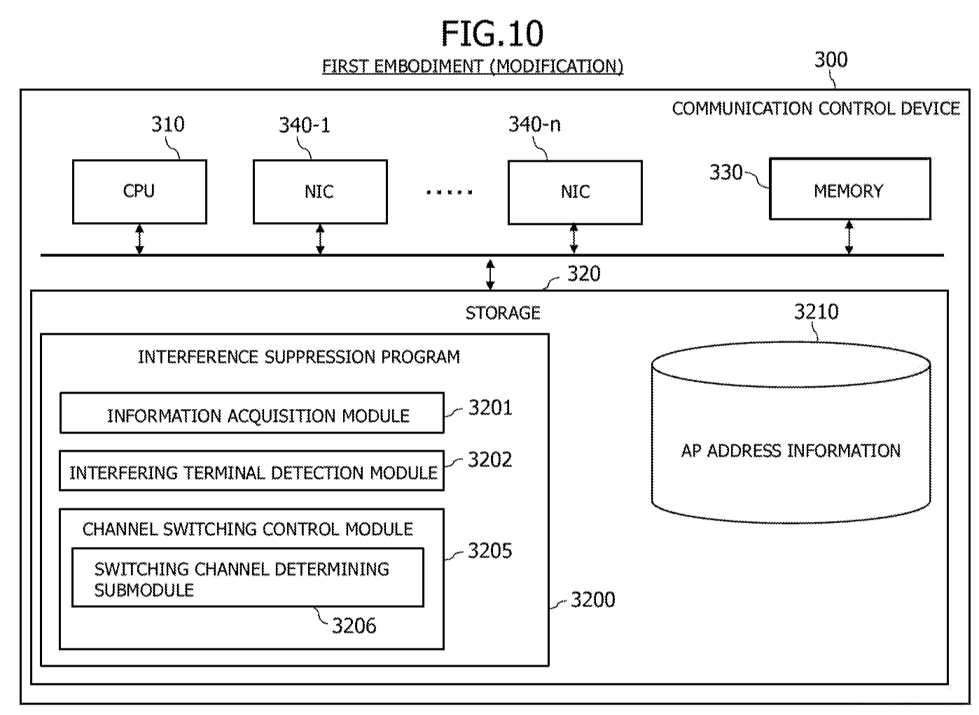

FIG. 10 is a diagram illustrating a configuration example of the communication control device 300.

The interference suppression program 3200 includes a channel switching control module 3205.

The CPU 310 constructs an interference suppression unit that executes a channel switching control process by executing the channel switching control module 3205. The channel switching control process is a process of requesting a communicating access point to switch a channel in communication with an interfering terminal device. The switched channel is a channel which does not interfere with a channel used by a hidden access point.

### Configuration Example of Access Point

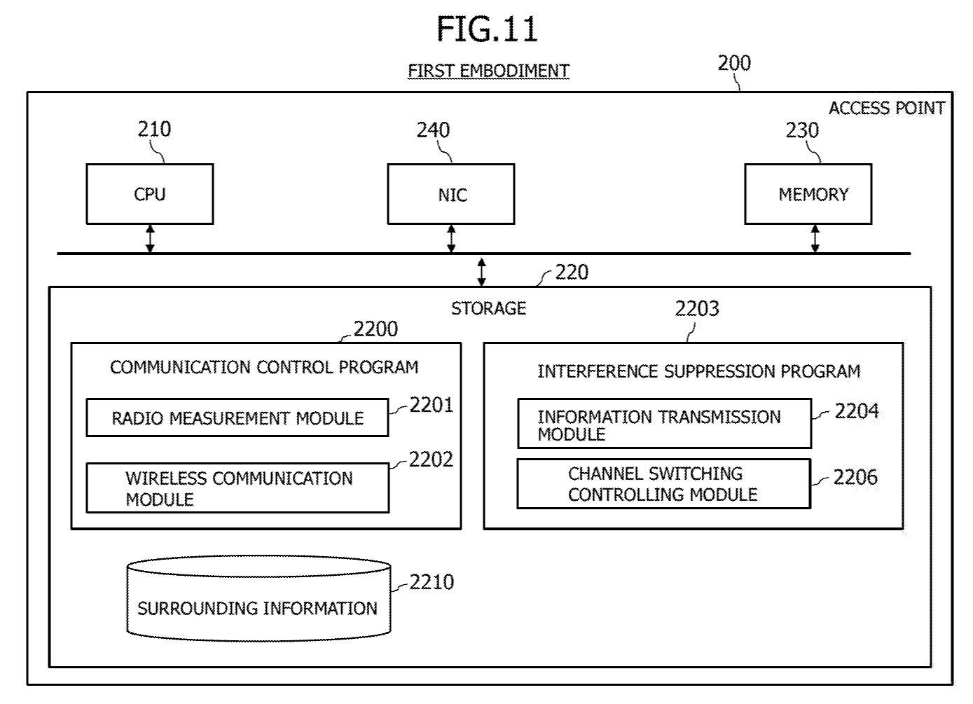

FIG. 11 is a diagram illustrating a configuration example of the access point 200.

The interference suppression program 2203 includes a channel switching controlling module 2206.

The CPU 210 realizes a channel switching controlling process by executing the channel switching controlling module 2206. The channel switching controlling process is a process of switching a channel used for communication with a terminal device according to an instruction from the communication control device 300. The communicating access point requests an interfering terminal device to switch a channel and changes a channel used for communication with the interfering terminal device.

### Interference Suppression Process

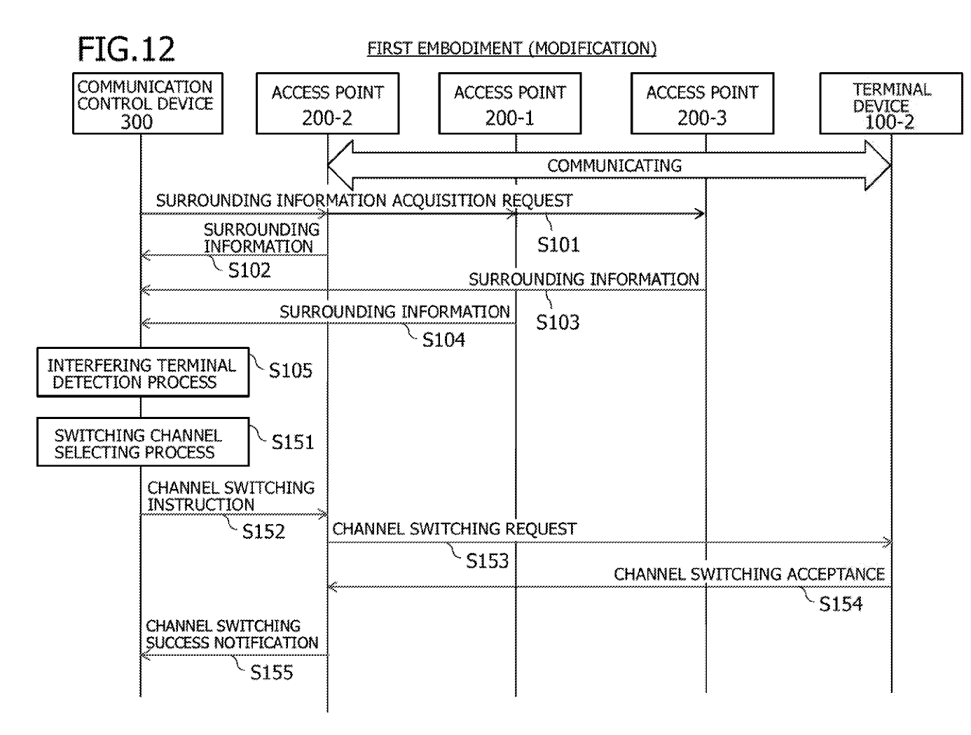

FIG. 12 is a diagram illustrating an example of the sequence of an interference suppression process.

In the first embodiment, although each access point can use only one channel for communication, a number of channels can be used in the modification.

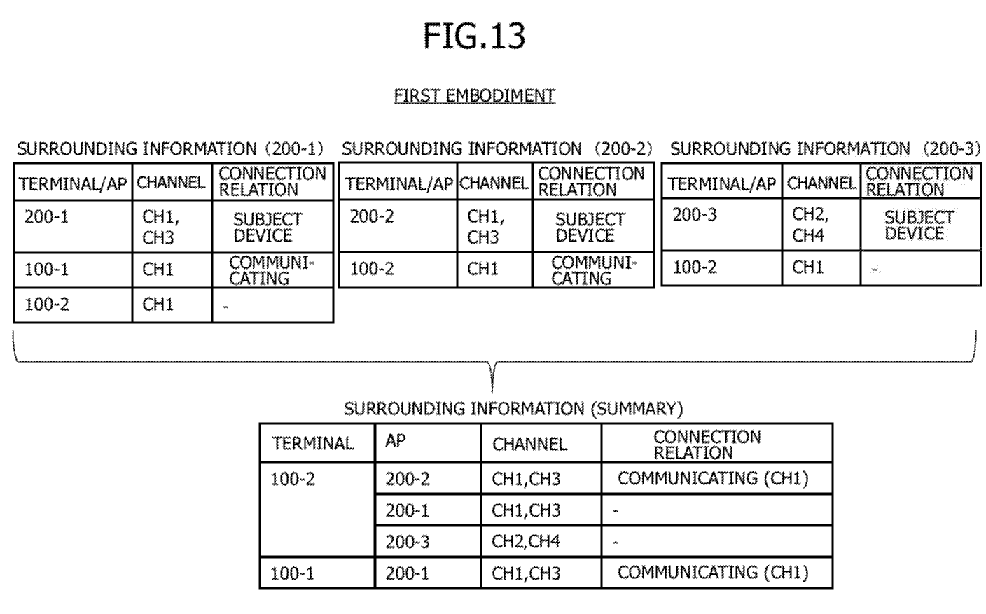

FIG. 13 is a diagram illustrating an example of surrounding information according to the modification. As illustrated in FIG. 13, in this modification, a case in which each access point can use two channels for communication will be described. In FIG. 13, unlike FIG. 6, the access points 200-1 and 200-2 can use channels CH1 and CH3 and the access point 200-3 can use channels CH2 and CH4. Moreover, the terminal device 100 can use all channels CH1 to CH4.

In FIG. 12, the processes from the surrounding information acquisition request (S102) to the interfering terminal device detection process (S105) are the same as those of the first embodiment. Hereinafter, the interference suppression process will be described with reference to FIG. 12.

The communication control device 300 performs a switching channel selecting process S151 when an interfering terminal device is detected in the interfering terminal detection process S105. The switching channel selecting process is a process of selecting a channel other than a channel being used for communication with the interfering terminal device among the channels which the access point in communication with the interfering terminal device can use. In the case of FIG. 13, the terminal device 100-2 which is an interfering terminal device performs communication with the access point 200-2 using the channel CH1. Referring to the “surrounding information (200-2),” since the access points 200-2 can use the channels CH1 and CH3, the communication control device 300 selects the channel CH3 which is not the channel CH1 being used for communication and which does not interfere with the channel CH1 as a switching channel. Although the access point 200-1 can use the channel CH3, the channel CH3 is currently not being used by the access point 200-1 and does not interfere with the access point 200-1. When selecting a switching channel, the communication control device 300 may check that there is no hidden access point which is using the switching channel. In the case of FIG. 13, since an access point which is using the channel CH3 is not present in the communication system 10, the communication control device 300 selects the channel CH3 as the switching channel.

Subsequently, when the switching channel is selected, the communication control device 300 creates a channel switching instruction.

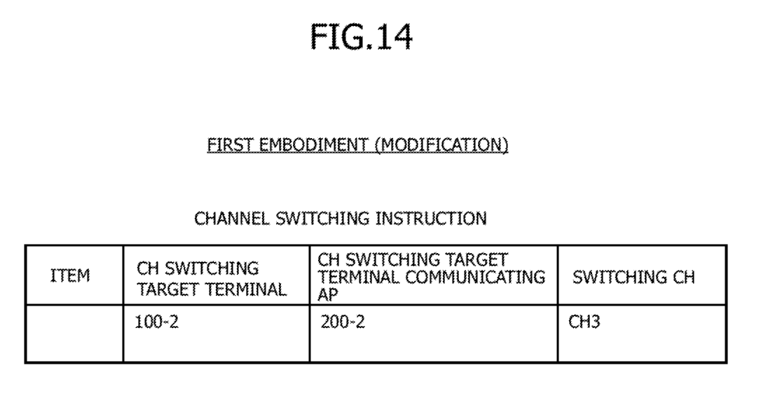

FIG. 14 is a diagram illustrating an example of a channel switching instruction. The channel switching instruction includes information such as “CH switching target terminal,” “CH switching target terminal communicating AP,” and “switching channel”. The “CH switching target terminal” is an interfering terminal device which is a channel switching target terminal device. In the case of FIG. 14, the “CH switching target terminal” is the identifier of the terminal device 100-2. The “CH switching target terminal communicating AP” is an identifier of an access point which is in communication with the interfering terminal device. In the case of FIG. 14, the “CH switching target terminal communicating AP” is an identifier of the access point 200-2 which is in communication with the terminal device 100-2. The “switching CH” is a candidate for the switching channel of the interfering terminal device. In the case of FIG. 14, the “switching CH” is the channel CH3 selected in the switching channel selecting process.

When the switching channel selecting process S151 is completed, the communication control device 300 transmits a channel switching instruction to the communicating access point (S152).

Upon receiving the channel switching instruction, the access point transmits a channel switching request to the terminal device 100-2 so as to switch a channel in communication (S153). Upon receiving the channel switching request, the terminal device 100-2 switches to a designated channel and transmits a channel switching acceptance to the access point 200-2 (S154).

Upon receiving the channel switching acceptance, the access point 200-2 transmits a channel switching success notification to the communication control device 300 (S155).

Channel switching may be performed by the same sequence as handover. In this case, since the same processes as those of the sequence of FIG. 5 except S107, S110, and S111 are performed, the channel switching operation will be described with reference to FIG. 5. The communication control device 300 transmits a channel switching instruction to the access points 200-1 to 200-3 (this process is a substitute for S107 in FIG. 5). The access point 200-2 which is the “CH switching target terminal communicating AP” disconnects the terminal device 100-2 (S108 in FIG. 5). The disconnected terminal device 100-2 broadcasts a connection request (S109 in FIG. 5). The access point 200-2 which is the “CH switching target terminal communicating AP” transmits a connection permission to the terminal device 100-2 (this process is a substitute for S110 in FIG. 5) and starts wireless communication using the channel CH3 designated in the “switching CH”. Moreover, the access point 200-2 transmits a channel switching success notification to the communication control device 300 (this process is a substitute for S111 in FIG. 5). On the other hand, the access points 200-1 and 200-3 which are not the “CH switching target terminal communicating AP” discard the received connection request. In this manner, channel switching may be performed by temporarily disconnecting the interfering terminal device and establishing new wireless communication using a switching channel.

The communication control device 300 may execute both the handover control process and the channel switching control process according to the first embodiment in combination. For example, the channel switching control process is executed in advance, and then, the handover control process is executed when it is not possible to select a candidate switching channel because only one channel can be used by an access point, for example.

In this way, the communication control device of the modification suppresses the occurrence of interference by switching the communication channel of the terminal device. Since a connection request which is broadcast in the handover process is not transmitted, for example, when it is possible to switch the channel without disconnecting the terminal device, it is possible to reduce the processing load and the power consumption of the terminal device.

### Second Embodiment

Next, a second embodiment will be described.

In the second embodiment, the process in which the communication control device 300 detects an interfering terminal device to hand the interfering terminal device over to another access point is the same as that of the first embodiment. However, in the second embodiment, the communication control device 300 controls a beacon transmitted by an access point in order to execute handover the interfering terminal device. The beacon is a signal that an access point transmits periodically, and a terminal device recognizes that the subject device is present in the communication area of the access point that has transmitted the beacon by receiving the beacon. Therefore, in the second embodiment, an interfering terminal device is executed handover to a handover candidate access point by adjusting the output power of the beacon.

### Interference Suppression Process

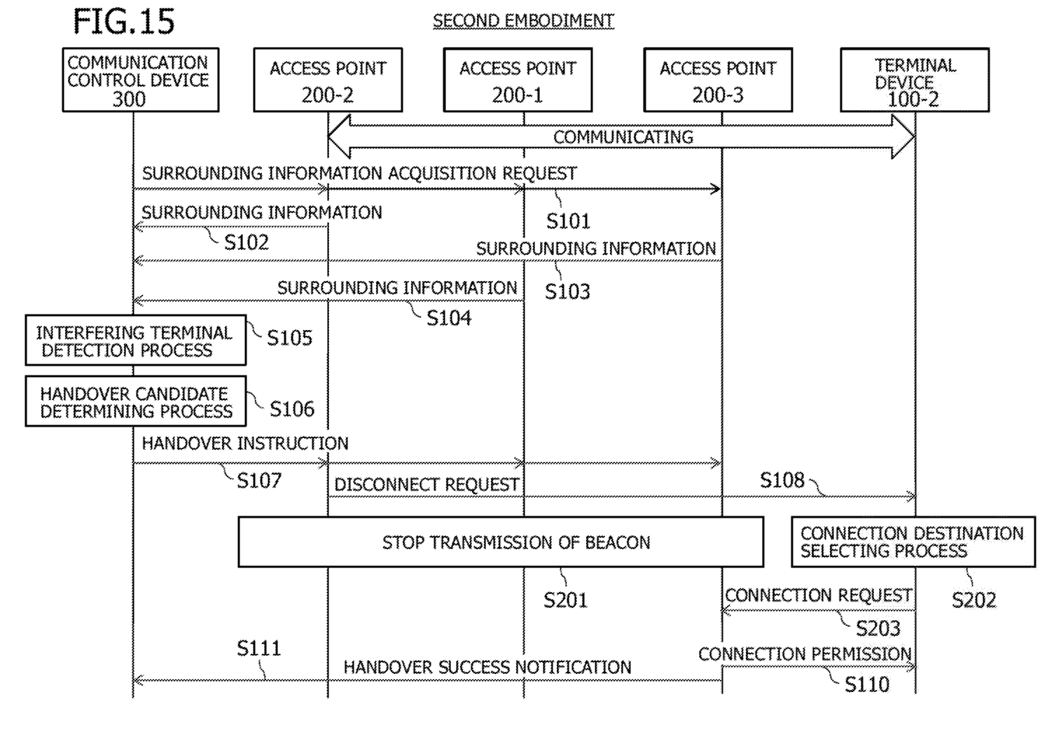

FIG. 15 is a diagram illustrating an example of the sequence of an interference suppression process. The processes from the surrounding information acquisition request (S101) to the disconnect request (S108) are the same as those of the first embodiment. The content of the handover instruction will be described using the example of FIG. 9 similarly to the first embodiment.

The terminal device 100-2 having received the disconnect request performs a connection destination selecting process (S202). The connection destination selecting process is a process of detecting access points within a communication area by receiving a beacon for a predetermined period and selecting a connecting access point. The terminal device 100-2 detects a source access point by receiving a beacon having a predetermined intensity or higher for a predetermined period, for example. The beacon includes the information on the identifier of the source access point, for example. The terminal device 100-2 may select an access point in which the reception power of the beacon is the highest as the connecting access point and may preferentially select an access point to which the terminal device had connected.

On the other hand, the access points 200-1 and 200-2 having received the handover instruction stop transmitting a beacon for a predetermined period since the subject devices are not the “HO candidate AP” (S201). In the period in which the access points 200-1 and 200-2 stop transmitting the beacon, only the handover candidate access point 200-3 transmits the beacon. Therefore, the terminal device 100-2 can receive only the beacon transmitted by the access point 200-3 in the connection destination selecting process S202 and selects the access point 200-3 as the candidate. The terminal device 100-2 transmits a connection request to the access point 200-3 selected as the connection destination (S203). The subsequent processes (S110 and S111) are the same as those of the first embodiment.

In the second embodiment, when a terminal device is performing a process of receiving a beacon, access points other than the handover candidate access point stop transmitting the beacon, the terminal device can detect the handover candidate access point only. In this way, the terminal device can connect to the handover candidate access point reliably.

In the embodiment, although the access points other than the handover candidate access point stop transmitting the beacon, the access points may decrease the transmission power so that the beacon does not arrive in the terminal device rather than stopping the transmission. Although other terminal devices cannot receive a beacon if access points stops transmitting the beacon, when the transmission power is decreased, another terminal device present in the arrival range of the beacon of which the output power is weakened can receive the beacon and perform communication with the access point.

### Third Embodiment

Next, a third embodiment will be described.

In the third embodiment, the communication control device 300 adjusts the beacon transmission timings of the communicating access point and the hidden access point. When the timings of the beacons of the communicating access point and the hidden access point are adjusted so that the beacons interfere with each other at the position of an interfering terminal device, the communicating access point and the hidden access point do not become a connection candidate of the interfering terminal device. As a result, the interfering terminal device can be executed handover to a handover candidate access point in which interference does not occur in the beacon.

### Interference Suppression Process

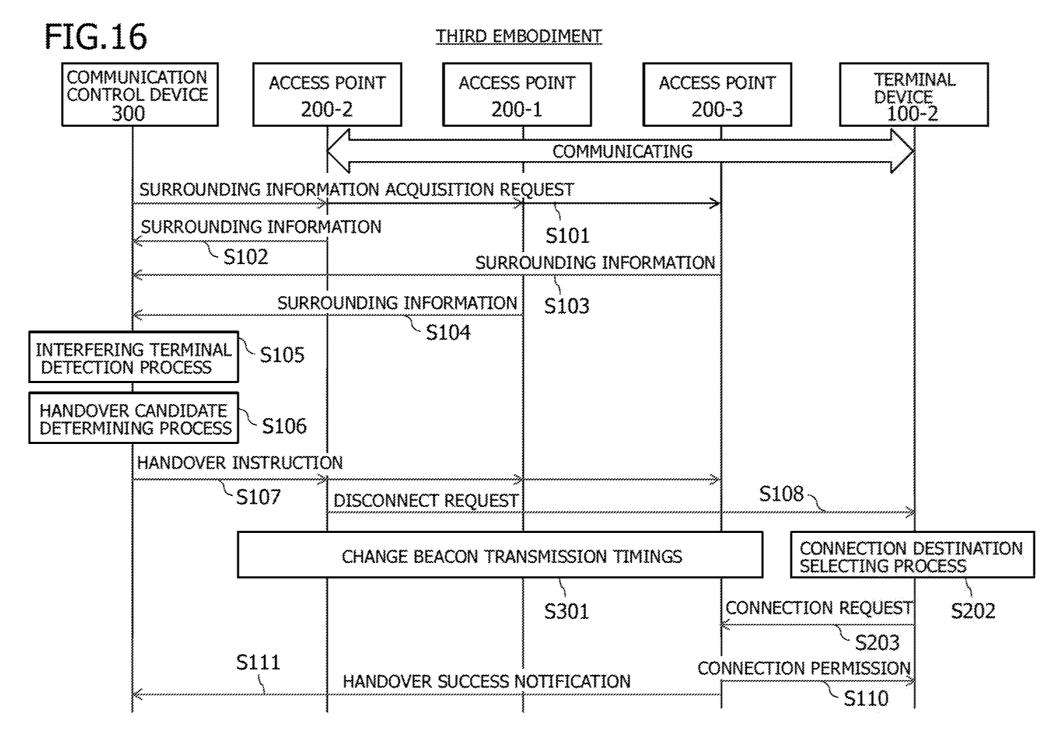

FIG. 16 is a diagram illustrating an example of the sequence of an interference suppression process. The processes from the surrounding information acquisition request (S101) to the disconnect request (S202) are the same as those of the second embodiment.

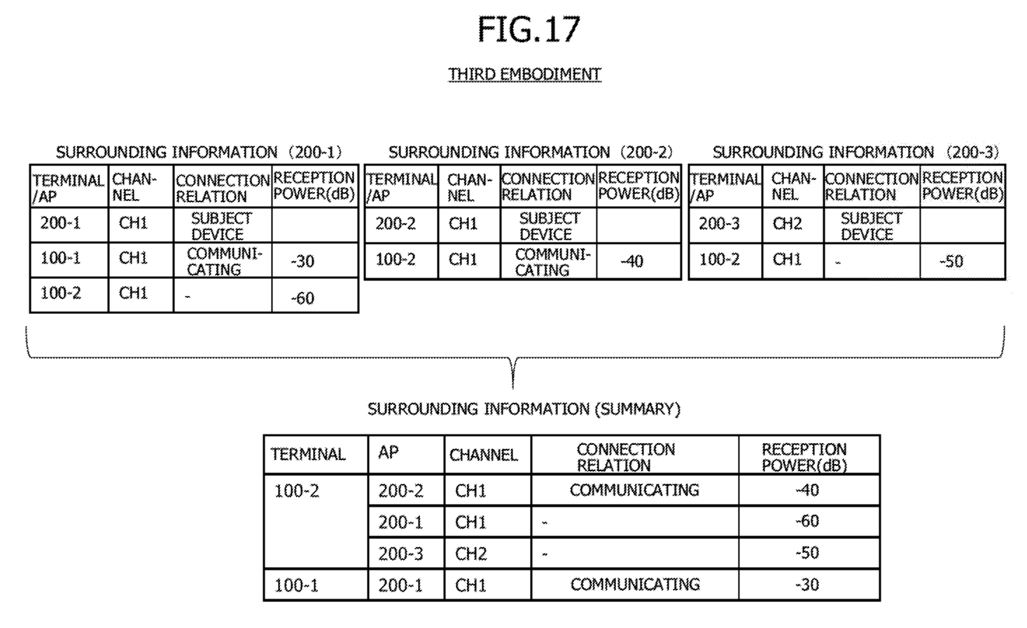

FIG. 17 is a diagram illustrating an example of surrounding information according to the third embodiment. The surrounding information includes “reception power (dB)” as an information element. The “reception power (dB)” is a value indicating the power intensity of received radio waves in radio measurement performed by each access point.

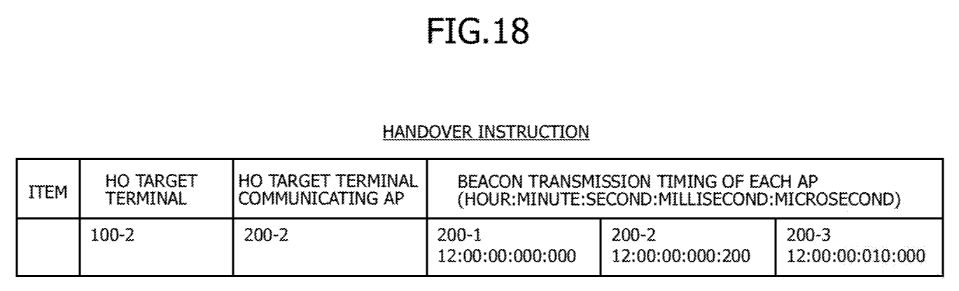

FIG. 18 is a diagram illustrating an example of a handover instruction according to the third embodiment. The information included in the handover instruction includes “HO target terminal,” “HO target terminal communicating AP,” and “beacon transmission timing of each AP”. The “HO target terminal” is an interfering terminal device which is a handover target terminal device. In the case of FIG. 18, the “HO target terminal” is the identifier of the terminal device 100-2. The “HO target terminal communicating AP” is an identifier of an access point which is in communication with the interfering terminal device. In the case of FIG. 18, the “HO target terminal communicating AP” is the identifier of the access point 200-2 which is in communication with the terminal device 100-2. The “beacon transmission timing of each AP” indicates the time at which each access point starts transmitting a beacon. In the case of FIG. 18, the beacon transmission start time of the access point 200-2 is “12:00:00:000:200” (hour:minute:second:millisecond:microsecond).

Returning to FIG. 16, the access points 200-1 to 200-3 having received the handover instruction change beacon transmission start timings according to the handover instruction (S301).

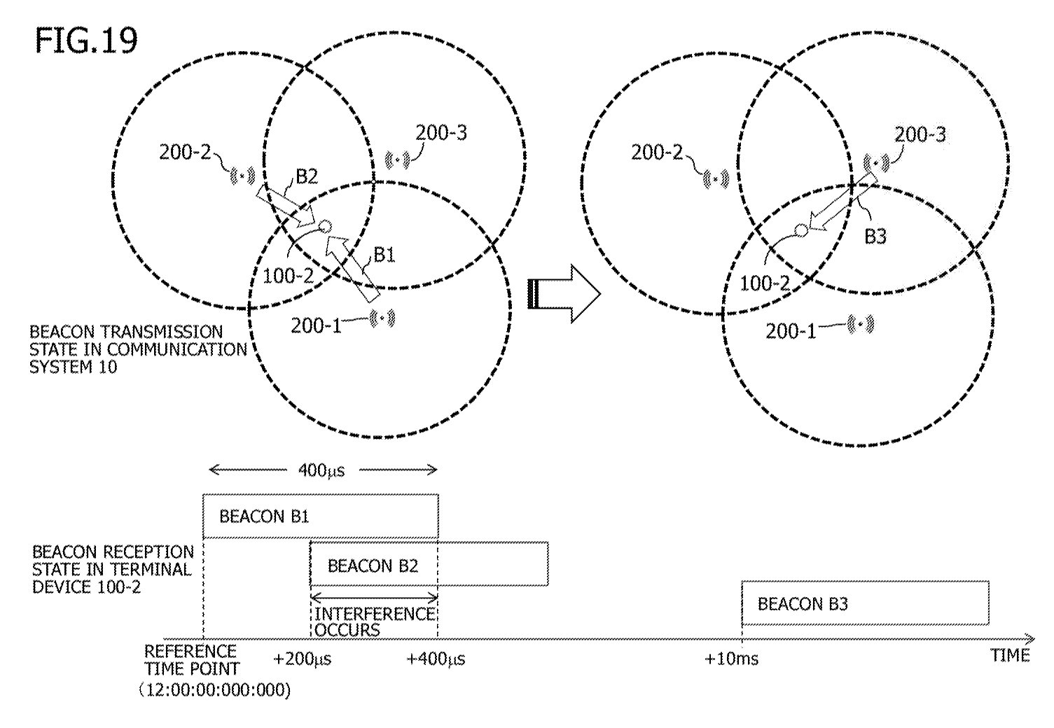

FIG. 19 is a diagram illustrating an example of beacons transmitted by the access points 200-1 to 200-3 and the states of the beacons received by the terminal device 100-2 in a time-sequential order. Since the time elapsed until a beacon arrives in the terminal device 100-2 after each access point starts transmitting the beacon is very short, the period is disregarded, and it is assumed that the time at which a beacon is transmitted is the time at which the beacon arrives in the terminal device 100-2.

The terminal device 100-2 receives a beacon B1 transmitted by the access point 200-1 at time 12:00:00:000:000 which is a reference time point. The terminal device 100-2 continuously receives the beacon B1 for a beacon transmission period (in FIG. 19, 400 microseconds) until the end of transmission of the beacon B1. At time point 12:00:00:000:200 which occurs 200 microseconds after the reference time point in which the terminal device 100-2 continuously receives the beacon B1, a beacon B2 transmitted by the access point 200-2 arrives in the terminal device 100-2. In a period (hereinafter referred to as a beacon overlapping period) until the time point which occurs 400 microseconds after 200 microseconds has elapsed from the reference time point, both the beacons B1 and B2 arrive in the terminal device 100-2. Since the beacons transmitted by the respective access points use the same channel, the beacons B1 and B2 interfere with each other in the beacon overlapping period. Therefore, since noise occurs in the beacon B1 received in the beacon overlapping period and the signal-to-interference noise ratio thereof is higher than a predetermined value, the terminal device 100-2 fails to receive the beacon B1. Moreover, since the terminal device 100-2 can receive only one beacon at a time, for example, the terminal device 100-2 cannot receive the beacon B2 as a beacon in the beacon overlapping period. Even if the terminal device 100-2 starts to receive the beacon B2 as a beacon after the elapse of the beacon overlapping period, transmission of the beacon B2 stops after 200 microseconds is elapsed. Therefore, the terminal device 100-2 cannot receive the beacon B2 for a period sufficient for recognizing the same as a beacon and fails to receive the beacon B2.

The terminal device 100-2 receives a beacon B3 transmitted by the access point 200-3 at time point 12:00:00:010:000 which occurs 10 milliseconds after the reference time point. The terminal device 100-2 continuously receives the beacon B3 for a predetermined period until the end of transmission of the beacon B3. Since the terminal device 100-2 receives the beacon B3 at a timing at which the beacons B1 and B2 do not interfere with each other, interference does not occur in the beacon B3, the signal-to-interference noise ratio thereof is lower than a predetermined value, and the terminal device 100-2 succeeds in receiving the beacon B3. Therefore, the terminal device 100-2 selects the access point 200-3 which is the transmitter of the beacon B3 as the connection destination.

Returning to FIG. 16, the terminal device 100-2 transmits a connection request to the access point 200-3 selected in the connection destination selecting process S202 (S203). The subsequent processes are the same as those of the second embodiment.

As described above, in the third embodiment, the transmission timings of the beacons transmitted by access points which are not the handover target are adjusted so as to partially overlap so that the interfering terminal device fails to receive the beacon and does not connect to the access points. In the third embodiment, since transmission of beacons is not stopped, although the interfering terminal device cannot connect to access points other than the handover target, other terminal devices can perform communication with the access points.

Moreover, in the third embodiment, the communication control device 300 adjusts the beacon transmission timings of respective access points so that a beacon from an access point in which the power intensity of radio waves received from the terminal device 100-2 is lower than the other access points arrives in the terminal device 100-2 earlier than the other beacons transmitted by the other access points. For the terminal device 100-2 to fail to receive the beacons B1 and B2, as described above, the signal-to-interference noise ratio of the beacon being received by the terminal device 100-2 may be higher than a predetermined value. That is, when interference as strong as possible occurs in the beacon being received by the terminal device 100-2, the possibility that the terminal device 100-2 fails to receive the beacon increases. If the timings at which the terminal device 100-2 receive the beacons B1 and B2 are completely simultaneous, since interference occurs in the entire beacon transmission period, the signal-to-interference noise ratio increases and the possibility of failing to receive the beacons increases. However, in an actual environment, since it takes a little time until beacons arrive in the terminal device 100-2 after the respective access points transmit the beacons, it is difficult to control the respective beacons to arrive completely at the same timings. Therefore, the beacon transmission timings are adjusted so that the terminal device 100-2 receives a beacon having a low reception power earlier than other beacons and a beacon having a high reception power arrives in the terminal device 100-2 in the period in which the terminal device 100-2 is receiving the beacon having a low reception power. The terminal device 100-2 recognizes that the other beacons received while the terminal device is receiving a certain beacon are noise components to the beacon being received. Therefore, the terminal device 100-2 receives noise having higher reception power than the beacon being received, and the signal-to-interference noise ratio is higher than when noise having lower reception power than the beacon being received is received, and the possibility of failing to receive the beacons increases. When the possibility of failing to receive beacons from access points other than the handover target increases, the possibility of succeeding in executing handover to the handover target access point increases.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication control device that controls base station devices each of which performs wireless communication with a terminal device, the communication control device comprising:
an information acquisition unit that acquires information on the base station device, and information on another base station device and a terminal device radio waves of which the base station device detects, from the base station device;
a terminal detection unit that detects an interfering terminal device being a terminal device, which is present in a communication area of a first base station device, and is in communication with a second base station device which is present outside the communication area of the first base station device and interferes with a radio wave that the first base station device uses for wireless communication, based on the information ; and
an interference suppression unit that issues an instruction for suppressing interference of a radio wave that the interfering terminal device uses for wireless communication to the second base station device based on the information.

2. The communication control device according to claim 1, wherein the information includes information on frequencies of radio waves that the base station device, and the another base station device and the terminal device, both of which are present in the communication area of the base station device, use for communication, and the instruction for suppressing interference of a radio wave that the interfering terminal device uses for wireless communication includes causing the interfering terminal device to execute handover to a third base station device which uses a radio wave of a frequency which does not interfere with the radio waves used by the first and second base station devices.

3. The communication control device according to claim 1, wherein
the information includes information on frequencies of radio waves that the base station device and the other base station device and the terminal device, both of which are present in the communication area of the base station device, use for communication, and
the instruction for suppressing interference of a radio wave that the interfering terminal device uses for wireless communication includes changing a frequency of the radio wave used by the second base station device to a frequency which does not interfere with the radio wave used by the first base station device.

4. The communication control device according to claim 1, wherein
the information includes information on frequencies of a radio wave that the base station device and the other base station device and the terminal device, both of which are present in the communication area of the base station device use for communication, and
the terminal detection unit detects the interfering terminal device when the frequencies of the radio waves used by the first and second base station devices are the same or as close as interfering with each other.

5. The communication control device according to claim 2, wherein
the interference suppression unit , in the process of causing the interfering terminal device to execute handover to the third base station device, instructs the second base station device to disconnect the connection with the interfering terminal device,
instructs the first and second base station devices not to connect the interfering terminal device, and
instructs the third base station device to connect the interfering terminal device.

6. The communication control device according to claim 2, wherein
upon receiving a beacon transmitted by a base station device, the terminal device recognizes that the terminal device is able to perform wireless communication with the base station device that has transmitted the beacon,
the interference suppression unit, in the process of causing interfering terminal device to execute handover to the third base station device, instructs the second base station device to disconnect the connection with the interfering terminal device and
instructs the first and second base station devices to stop transmitting beacons or decrease transmission power of the beacon so that the beacons do not arrive in the interfering terminal device.

7. The communication control device according to claim 2, wherein
upon receiving a beacon transmitted by a base station device, the terminal device recognizes that the terminal device is able to perform wireless communication with the base station device that has transmitted the beacon,
the interference suppression unit, in the process of causing the interfering terminal device to execute handover to the third base station device, instructs the second base station device to disconnect the connection with the interfering terminal device, and
instructs the first and second base station to adjust transmission timings of first and second beacons transmitted by the first and second base station devices, respectively, such that the first and second beacons interfere with each other at the position of the interfering terminal device.

8. The communication control device according to claim 7, wherein
the interference suppression instructs the first and second base station to adjust the transmission timings of the first and second beacons such that a period from a start to an end of transmission of the first beacon and a period from a start to an end of transmission of the second beacon overlap at least partially.

9. The communication control device according to claim 8, wherein
the information includes information on reception strength, in the base station device, of the radio waves received by the terminal device, and
the interference suppression unit adjusts the transmission timings so that a beacon transmitted from an access point in which the reception intensity of the radio waves transmitted by the interfering terminal device is low arrives in the interfering terminal device earlier than the other beacon.

10. The communication control device according to claim 1, wherein
the base station device is a base station device that forms a local area network.

11. The communication control device according to claim 1, wherein the base station device is able to use one frequency.

12. A communication control method of controlling a base station device that performs wireless communication with a terminal device, the method comprising:
acquiring information on the base station device, and information on another base station device and a terminal device radio waves of which the base station device detects, from the base station device;
detecting an interfering terminal device being a terminal device, which is present in a communication area of a first base station device, and is in communication with a second base station device which is present outside the communication area of the first base station device and interferes with a radio wave that the first base station device uses for wireless communication, based on the information; and
issuing an instruction for suppressing interference of a radio wave that the interfering terminal device uses for wireless communication to the second base station device based on the information.

13. A communication control device that controls a base station device that performs wireless communication with a terminal device, the communication control device comprising:
a memory; and
a processor coupled to the memory and the processor configured to:
acquire information on the base station device, and information on another base station device and a terminal device radio waves of which the base station device detects, from the base station device;
detect an interfering terminal device being a terminal device, which is present in a communication area of a first base station device, and is in communication with a second base station device which is present outside the communication area of the first base station device and interferes with a radio wave that the first base station device uses for wireless communication, based on the information; and
issue an instruction for suppressing interference of a radio wave that the interfering terminal device uses for wireless communication to the second base station device based on the information.
